(19) United States
(12) Patent Application Publication
(10) Pub. No.: US 2012/0249939 A1
(43) Pub. Date: Oct. 4, 2012

(54) LIQUID CRYSTAL DISPLAY DEVICE WITH RETARDATION COMPENSATION

(76) Inventors: Hee Wook DO, Cheonan-si (KR); Duckjong Suh, Seoul (KR); Jung-Hun Lee, Seoul (KR); Boo-Kan Ki, Seoul (KR); Min Oh Choi, Asan-si (KR); Sang-Gu Lee, Seoul (KR)

(21) Appl. No.: 13/352,206

(22) Filed: Jan. 17, 2012

(30) Foreign Application Priority Data
Mar. 31, 2011 (KR) 10-2011-0029805

(51) Int. Cl. G02F 1/1335

(52) U.S. Cl. 349/117

(57) ABSTRACT

A liquid crystal device includes a twisted nematic liquid crystal panel and first and second retardation films disposed on the top and bottom sides of the twisted nematic liquid crystal panel. A retardation compensation range angle between an axis of the first retardation film and an axis of the second retardation film is smaller than a twist range angle between a first twist axis representing the average of twist angles of lower liquid crystals and a second twist axis representing the average of twist angles of upper liquid crystals in a plan view of the liquid crystal display device.

### CROSS-REFERENCE TO RELATED APPLICATIONS

This U.S. non-provisional patent application claims priority under 35 U.S.C. §119 of Korean Patent Application No. 10-2011-0029805, filed on Mar. 31, 2011, the entire contents of which are hereby incorporated by reference.

### BACKGROUND

The present disclosure herein relates to a liquid crystal display device, and more particularly, to a liquid crystal display device having an improved front contrast ratio.

Typically, a liquid crystal display device may include a liquid crystal panel, and a pair of polarizers disposed on the top and bottom sides of the liquid crystal panel. In general, the liquid crystal panel includes an array substrate in which a plurality of pixels are arranged in a matrix format, an opposite substrate disposed at a side opposite to the array substrate, and a liquid crystal layer disposed between the array substrate and the opposite substrate. The liquid crystal panel has various liquid crystal modes according to the alignment and phase of liquid crystal molecules of the liquid crystal layer. There are various types of liquid crystal panels, including nematic liquid crystal panels using nematic liquid crystals and smectic liquid crystal panels using smectic liquid crystals.

Twisted nematic liquid crystal display devices are the most representative devices of nematic liquid crystal display devices, which comprise nematic liquid crystal panels. As compared with other types of liquid crystal display devices, twisted nematic liquid crystal display devices have relatively high light transmittance. However, the viewing angle of the twisted nematic liquid crystal display devices is narrow.

For this reason, discotic liquid crystal (DLC) compensation films are used for twisted nematic liquid crystal display devices to improve the viewing angle of the twisted nematic liquid crystal display devices. DLC compensation films are formed by coating tri-acetyl-cellulose films with discotic liquid crystals. However, DLC compensation films are fabricated through complicated processes with high costs.

### SUMMARY

One or more embodiments of the present invention are related to a liquid crystal display device including a pair of retardation films for improving a front contrast ratio.

The liquid crystal display device includes a twisted nematic liquid crystal panel, a first retardation film disposed at a bottom side of the twisted nematic liquid crystal panel, and a second retardation film disposed at a top side of the twisted nematic liquid crystal panel. The twisted nematic liquid crystal panel includes a first substrate defining a first alignment axis, a second substrate opposite to the first substrate and defining a second alignment axis, and liquid crystals gradually twisted from the first alignment axis to the second alignment axis. If an electric field is applied to the liquid crystals, the liquid crystals include lower liquid crystals having twist angles in a first range, upper liquid crystals having twist angles in a second range different from the first range, and intermediate liquid crystals disposed between the upper and lower liquid crystals. The first retardation film is disposed at the bottom side of the first substrate. A refractive index of the first retardation film in a first axis of the first retardation film is greater than a refractive index of the first retardation film in a second axis of the first retardation film, wherein the first axis of the first retardation film and the second axis of the first retardation film are parallel with a surface of the first retardation film. The second retardation film is disposed at the top side of the second substrate. A refractive index of the second retardation film in a first axis of the second retardation film is greater than a refractive index of the second retardation film in a second axis of the second retardation film, wherein the first axis of the second retardation film and the second axis of the second retardation film are parallel with a surface of the second retardation film. A retardation compensation range angle between the second axis of the first retardation film and the second axis of the second retardation film in a plan view of the liquid crystal display device is smaller than a twist range angle between a first twist axis representing an average of the twist angles of the lower liquid crystals and a second twist axis representing an average of the twist angles of the upper liquid crystals in the plan view of the liquid crystal display device.

In one or more embodiments, the liquid crystal display device may further include a first polarizer disposed at a bottom side of the first retardation film and associated with a first transmission axis; the liquid crystal display device may further include a second polarizer disposed at a top side of the second retardation film and associated with a second transmission axis.

In one or more embodiments, the second axis of the first retardation film and the second axis of the second retardation film may be disposed between the first and second alignment axes in the plan view of the liquid crystal display device.

One or more embodiments of the invention are related to a liquid crystal display device that includes a twisted nematic liquid crystal panel, a lower polarizer disposed at a bottom surface of the twisted nematic liquid crystal panel and associated with a first transmission axis, and an upper polarizer disposed at a top surface of the twisted nematic liquid crystal panel and associated with a second transmission axis perpendicular to the first transmission axis. The liquid crystal display device may further include a lower retardation film disposed between the twisted nematic liquid crystal panel and the lower polarizer, wherein a refractive index of the lower retardation film in a first axis of the lower retardation film is greater than a refractive index of the lower retardation film in a second axis of the lower retardation film, the first axis of the lower retardation film and the second axis of the lower retardation film being parallel with a surface of the lower retardation film. The liquid crystal display device may further include an upper retardation film disposed between the twisted nematic liquid crystal panel and the upper polarizer, wherein a refractive index of the upper retardation film in a first axis of the upper retardation film is greater than a refractive index of the upper retardation film in a second axis of the upper retardation film, the first axis of the upper retardation film and the second axis of the upper retardation film being parallel with a surface of the upper retardation film. A retardation compensation range angle between the second axis of the lower retardation film and the second axis of the upper retardation film in the plan view of the liquid crystal display device is smaller than an angle between the first transmission axis and the second transmission axis in a plan view of the liquid crystal display device, and the second axis of the lower retardation film and the second axis of the upper retardation film are provided between the first transmission axis and the second transmission axis in the plan view of the liquid crystal display device.

### BRIEF DESCRIPTION OF THE DRAWINGS

The accompanying drawings are included to provide a further understanding of the invention, and are incorporated in and constitute a part of this specification. The drawings illustrate one or more embodiments of the invention and, together with the description, serve to explain principles of the invention. In the drawings:

FIG. 1 is a cross-sectional view illustrating a liquid crystal display device according to an embodiment of the invention;

FIG. 2 is a plan view illustrating an array substrate of the liquid crystal display device of FIG. 1;

FIG. 3 is a cross-sectional view taken along line I-I′ of FIG. 2;

FIG. 4 is a schematic view for explaining light propagation characteristics when the liquid crystal display device of FIG. 1 is in a inactive state;

FIG. 5 is a schematic view for explaining light propagate characteristics when the liquid crystal display device of FIG. 1 is in an active state;

FIGS. 6 and 7 are graphs illustrating twist and tilt angles of liquid crystal molecules in FIG. 5;

FIG. 8 is a view for explaining a retardation film of the liquid crystal display device of FIG. 1;

FIG. 9 is a view for explaining a relationship between a twist range angle and a retardation compensation range angle;

FIG. 10 is cross-sectional view illustrating a liquid crystal display device according to an embodiment of the invention; and

FIG. 11 is a graph illustrating the front contrast ratio of the liquid crystal display device of FIG. 1.

### DETAILED DESCRIPTION OF THE EMBODIMENTS

One or more embodiments of the invention will be described below in more detail with reference to the accompanying drawings. The invention may, however, be embodied in different forms and should not be construed as limited to the embodiments set forth herein. Various modifications, equivalents, and substitutes may be provided within the scope and spirit of the invention.

In the following descriptions of the drawings, like reference numerals refer to like elements. In addition, the dimensions of elements are exaggerated for clarity of illustration. It will be understood that although the terms first and second are used herein to describe various elements, these elements should not be limited by these terms. These terms are used only to discriminate one element from another element. For example, an element referred as a first element in one embodiment may be referred to as a second element in another embodiment, and an element referred to as a second element in one embodiment may be referred to as a first element so long as this naming does not obscure the scope of the invention. The terms of a singular form may include plural forms unless referred to the contrary.

The meaning of “include,” “comprise,” “including,” or “comprising,” specifies a property, a region, a fixed number, a step, a process, an element, and/or a component but does not exclude other properties, regions, fixed numbers, steps, processes, elements and/or components. It will also be understood that when an element such as a layer, a film, a region, and a plate is referred to as being ‘on’ another element, it can be directly on the other element, or one or more intervening elements may also be present.

Hereinafter, one or more embodiments of the invention will be described in detail with reference to the accompanying drawings.

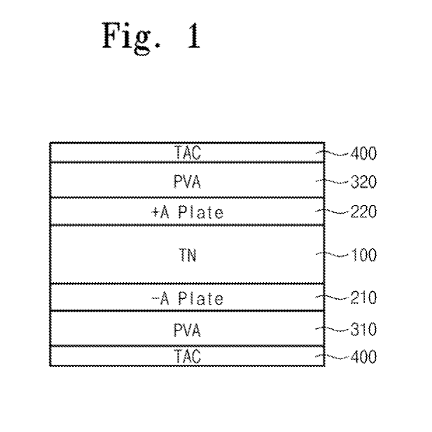

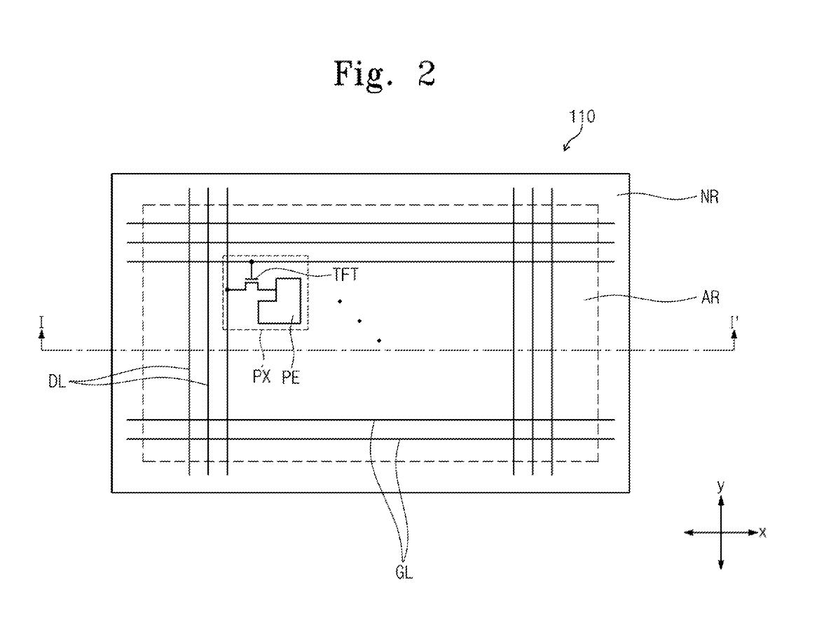

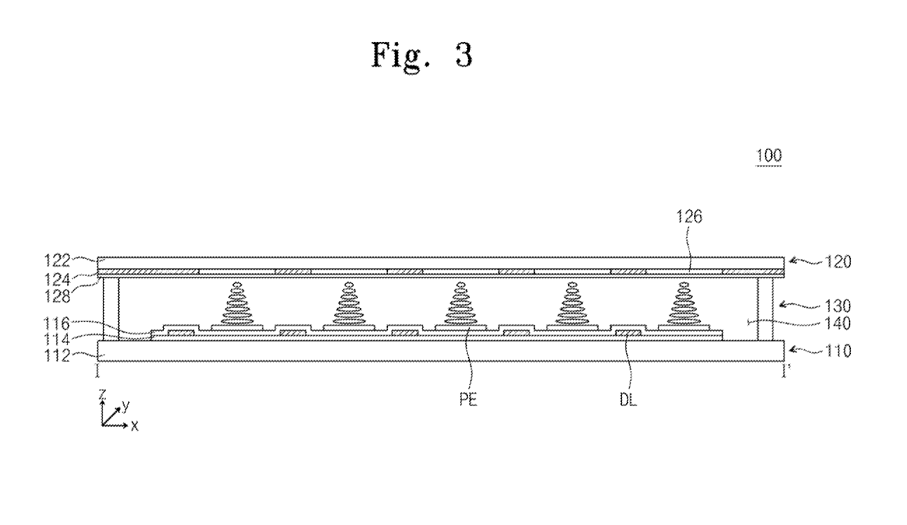

FIG. 1 is a cross-sectional view illustrating a liquid crystal display device according to an embodiment of the invention, FIG. 2 is a plan view illustrating an array substrate of the liquid crystal display device of FIG. 1, and FIG. 3 is a cross-sectional view taken along line I-I′ of FIG. 3.

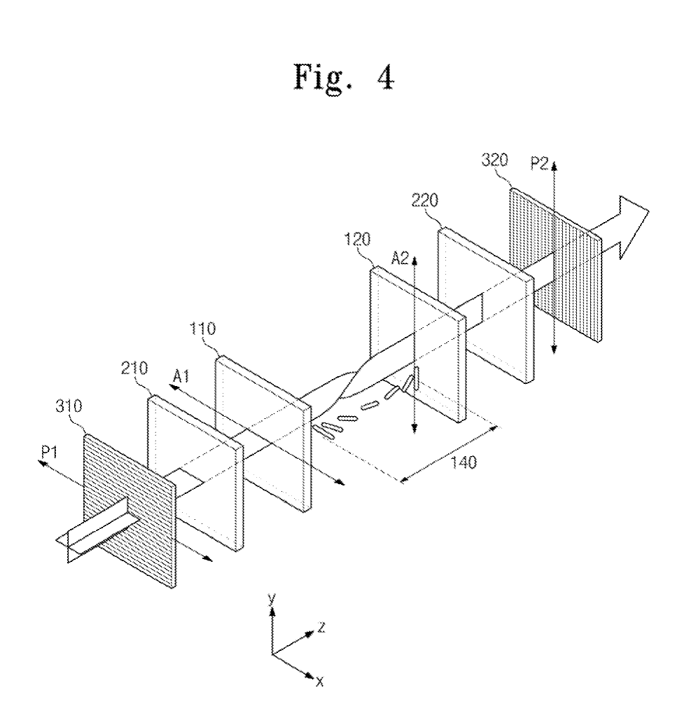

Referring to FIG. 1, the liquid crystal display device includes a twisted nematic liquid crystal panel 100 (hereinafter referred to as liquid crystal panel 100), a first retardation film 210 disposed on the bottom side of the liquid crystal panel 100, and a second retardation film 220 disposed on the top side of the twisted nematic liquid crystal panel 100. The liquid crystal display device further includes a first polarizer 310 disposed on the bottom side of the first retardation film 210 and having a first transmission axis P1 (illustrated in the example of FIG. 4). The liquid crystal display device further includes a second polarizer 320 disposed on the top side of the second retardation film 220 and having a second transmission axis P2 (illustrated in the example of FIG. 4).

As shown in FIGS. 2 and 3, the liquid crystal panel 100 includes an array substrate 110, an opposite substrate 120 disposed at a side opposite to the array substrate 110, a coupling member 130 configured to couple the array substrate 110 with the opposite substrate 120, and liquid crystals 140 disposed between the array substrate 110 and the opposite substrate 120.

The array substrate 110 includes a first substrate 112 including an active region AR and a non-active region NR, a plurality of gate lines GL disposed on the first substrate 112, and a plurality of data lines DL crossing the gate lines to define a plurality of pixel regions.

The first substrate 112 is formed of a transparent material such as glass, plastic, and/or silicon. The active region AR of the first substrate 112 receives light from a light source (not shown) such as a backlight unit, and the non-active region NR adjoins the active region AR.

A plurality of pixels PX corresponds to the pixel regions in a one-to-one relation. The pixels PX have the same structure and function, and thus the structure and function of the pixels PX will be described by taking one of the pixels PX as an example. Each of the pixels PX includes a thin film transistor TFT as a switching device for a pixel voltage corresponding to an image, and a pixel electrode PE electrically connected to the thin film transistor TFT.

The thin film transistor TFT includes a gate electrode, a source electrode, and a drain electrode. The gate electrode branches off from one of the gate lines GL formed on the first substrate 112. A gate insulation layer 114 is disposed on the first substrate 112 to cover the gate lines GL and the gate electrode branching off from the gate lines GL. An active layer is disposed on the gate insulation layer 114, and the source electrode and the drain electrode are disposed on the active layer at a predetermined distance from each other so that the active layer can be exposed. The data lines DL are disposed on the gate insulation layer 114. The source electrode branches off from one of the data lines DL.

A protection layer 116 is formed on the gate insulation layer 114 by using an insulating material to cover the source electrode, the drain electrode, and the exposed active layer. The pixel electrode PE is disposed on the protection layer 116 and is electrically connected to the drain electrode of the pixel PX through a contact hole.

The opposite substrate 120 includes a second substrate 122 facing the first substrate 112 of the array substrate 110. The opposite substrate 120 further includes a common electrode 128 disposed on a side facing the array substrate 110.

The second substrate 122 may be formed of the same material as that used to form the first substrate 112. The opposite substrate 120 may further include a shield member 124 called “black matrix” and color filters 126. The shield member 124 includes a plurality of opening regions that face the pixel electrodes PE and have the same shape as the pixel electrodes PE. A plurality of color filters 126 may be disposed on the opening regions of the shield member 124. The color filters 126 may face the pixel electrodes PE. Each of the color filter 126 may have a long band shape and may be used to express one of red, green, and blue colors.

The coupling member 130 is disposed at the non-active region NR between the array substrate 110 and the opposite substrate 120. The coupling member 130 surrounds the active region AR to seal the liquid crystals 140 disposed between the array substrate 110 and the opposite substrate 120.

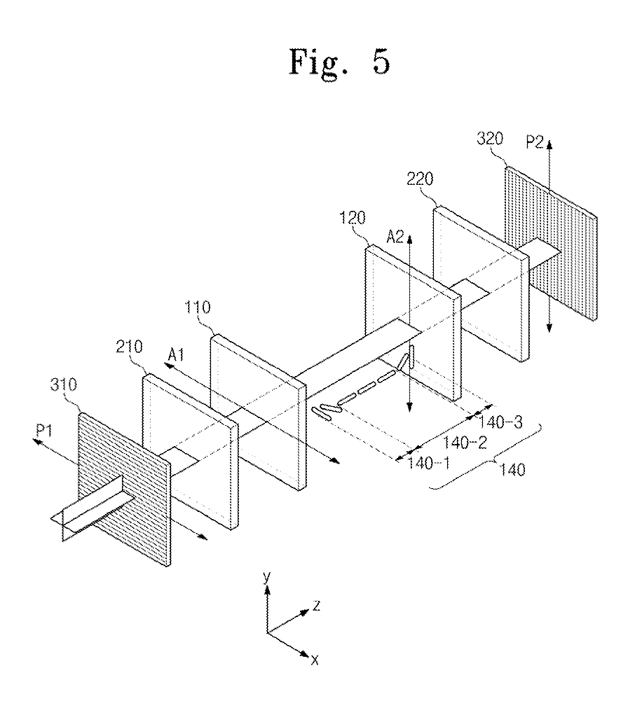

Alignment layers (not shown) are disposed on mutually facing surfaces of the first substrate 112 and the second substrate 122. One of the alignment layers may be formed by applying an alignment layer material to the pixel electrodes PE and the protection layer 116 (disposed on the first substrate 112) to a thickness of about hundreds of angstroms (Å) and rubbing the alignment layer material in a first direction (first alignment axis A1 illustrated in the examples of FIGS. 4 and 5). The other of the alignment layers may be formed by applying an alignment layer material to common electrode 128 (disposed on the second substrate 122) and rubbing the alignment layer material in a second direction (second alignment axis A2 as illustrated in the examples of FIGS. 4 and 5).

In the twisted nematic liquid crystal panel 100, the first alignment axis A1 and the second alignment axis A2 are perpendicular to each other. In a state where an electric field is not formed between the array substrate 110 and the opposite substrate 120 (in an inactive state), the liquid crystals 140 are gradually twisted from the first alignment axis A1 to the second alignment axis A2. In a state where an electric field is formed between the array substrate 110 and the opposite substrate 120 (in an active state), the liquid crystals 140 are realigned. In the active state, an optical activation effect or a birefringence effect is not substantially given by the liquid crystals 140. Therefore, propagation characteristics of light passing through the liquid crystals 140 in the active state are different from those of light passing through the liquid crystals 140 in the inactive state.

Hereinafter, with reference to FIGS. 4 and 5, alignment of the liquid crystals 140 and light propagation characteristics of the liquid crystals 140 depending on whether an electric field is applied to the liquid crystals 140 will be explained. FIGS. 4 and 5 illustrate an example of a normally white mode for displaying white in an inactive state.

First, alignment and light propagation characteristics of the liquid crystals 140 will be described in an inactive state with reference to FIG. 4. Liquid crystals of the liquid crystals 140 close to the array substrate 110 are aligned in parallel with the first alignment axis A1, and liquid crystals of the liquid crystals 140 close to the opposite substrate 120 are aligned in parallel with the second alignment axis A2. The liquid crystals 140 are gradually twisted from those close to the array substrate 110 to those close to the opposite substrate 120 without any tilt angle or with only a slight tilt angle.

Scattering light coming from the backlight unit (not shown) such as an LED package or an incandescent lamp is linearly polarized by the first polarizer 310 so that only a linear component of the scattering light parallel with a first polarization axis P1 (first transmission axis P1) of the first polarizer 310 passes through the first polarizer 310 and the rest of the scattering light is absorbed. The linearly polarized light is twisted by about 90° while passing through the liquid crystals 140, and then the linearly polarized light passes through the second polarizer 320 to display white.

In the liquid crystal display device operating in the normally white mode, the first transmission axis P1 of the first polarizer 310 is substantially parallel with the first alignment axis A1, and the second transmission axis P2 of the second polarizer 320 is substantially parallel with the second alignment axis A2. That is, the first transmission axis P1 and the second transmission axis P2 are substantially perpendicular to each other. The first transmission axis P1 and the second transmission axis P2 may make an angle of 90°.

Although a normally white mode is illustrated in FIGS. 4 and 5, the liquid crystal display device may be configured to operate in a normally black mode. In this case, the first transmission axis P1 and the second transmission axis P2 are substantially parallel to each other. That is, linearly polarized light from the first polarizer 310 is twisted by about 90° while passing through the liquid crystals 140, and the twisted polarized light does not pass through the second polarizer 320 so that black is displayed.

With reference to FIG. 5, alignment and light propagation characteristics of the liquid crystals 140 will now be described. In an active mode, if an electric field is applied to the liquid crystals 140, the liquid crystals 140 are realigned and divided into lower liquid crystals 140-1, intermediate liquid crystals 140-2, and upper liquid crystals 140-3.

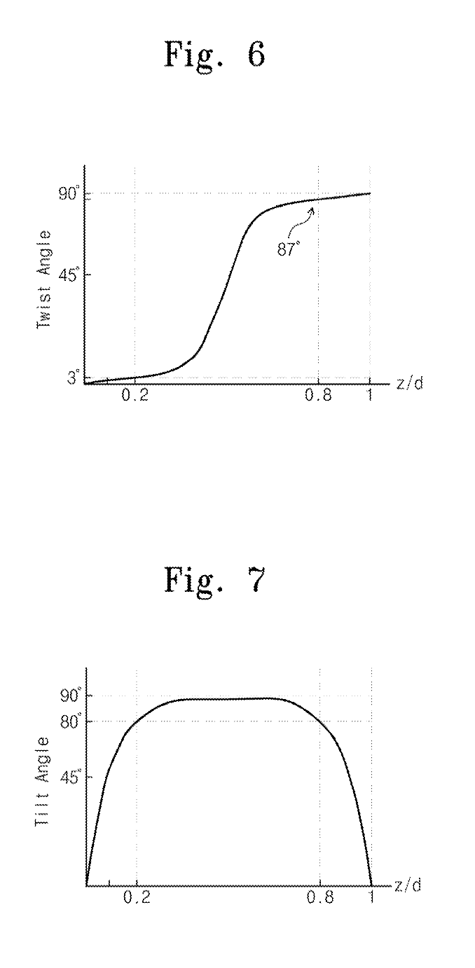

That is, in the active state, the liquid crystals 140 may be divided into three liquid crystals having twist angles and tilt angles as shown in FIGS. 6 and 7. The tilt angle of the lower liquid crystals 140-1 is decreased with respect to the first alignment axis A1, and the tilt angle of the upper liquid crystals 140-3 is increased with respect to the first alignment axis A1. As a whole, the tilt angle of the liquid crystals 140 is increased with respect to the first alignment axis A1.

Referring to FIG. 6, the twist angle of the lower liquid crystals 140-1 is in the range from 0° to 3° (first range) with respect to the first alignment axis A1. The lower liquid crystals 140-1 having a twist angle in the first range are arranged in a lower 20% region between the array substrate 110 and the opposite substrate 120.

The twist angle of the upper liquid crystals 140-3 is in the range from 87° to 90° (second range) with respect to the first alignment axis A1. The upper liquid crystals 140-3 having a twist angle in the second range are arranged in an upper 20% region between the array substrate 110 and the opposite substrate 120.

The intermediate liquid crystals 140-2 are disposed between the lower liquid crystals 140-1 and the upper liquid crystals 140-3. The intermediate liquid crystals 140-2 have a twist angle in a wide range with reference to the first alignment axis A1.

Referring to FIG. 7, the tilt angle of the intermediate liquid crystals 140-2 is greater than those of the lower liquid crystals 140-1 and the upper liquid crystals 140-3. Therefore, light passing through the liquid crystals 140 is not substantially retarded by the intermediate liquid crystals 140-2.

Since the intermediate liquid crystals 140-2 having a large tilt angle are substantially perpendicular to the array substrate 110 and the opposite substrate 120 (that is, the intermediate liquid crystals 140-2 are substantially parallel with a light propagation direction), propagation of light may not be affected by the intermediate liquid crystals 140-2. However, since the tilt angles of the lower liquid crystals 140-1 and the upper liquid crystals 140-3 are smaller than the tilt angle of the intermediate liquid crystals 140-2, light may be retarded by the lower liquid crystals 140-1 and the upper liquid crystals 140-3.

Referring the active state shown in FIG. 5, when scattering light is incident on the first polarizer 310, only a linear polarization component of the scattering light parallel with the first polarization axis P1 (first transmission axis P1) passes through the first polarizer 310, and the other components of the scattering light are absorbed by the first polarizer 310. Although the linear polarization component passes through the realigned liquid crystals 140, the linear polarization component does not pass through the second polarizer 320; as a result, black is displayed. In the active state, since the lower liquid crystals 140-1 and the upper liquid crystals 140-3 are not substantially perpendicular to the array substrate 110 or the opposite substrate 120 but are tilted, linearly polarized light is retarded while the linearly polarized light passes through the liquid crystals 140. Such retardation lowers the front contrast ratio of the liquid crystal display.

To prevent this, the liquid crystal display device of the embodiment includes the first retardation film 210 and the second retardation film 220 as shown in FIGS. 1, 4, and 5.

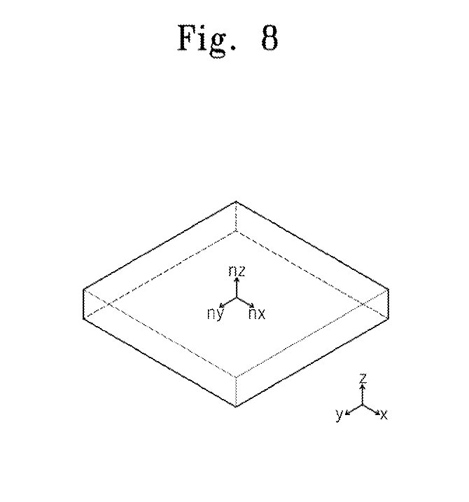

The first retardation film 210 and the second retardation film 220 will be described with reference to FIG. 8. The first and second retardation films 210 and 220 compensate for retardation caused by the liquid crystals 140 (illustrated in the examples of FIGS. 4 and 5) in an opposite direction. Therefore, an optical activation effect or a birefringence effect can be prevented in regions of the liquid crystal display device that display black, and thus the front contrast ratio of the liquid crystal device can be improved.

Referring to FIG. 8, a material has an x-direction refraction index nx, a y-direction refraction index ny, and a z-direction refraction index nz. If the refraction indexes nx, ny, and nz are equal, the material is called “isotropic,” and if all or some of the refraction indexes nx, ny, and nz are not equal, the material is called “anistropic.” If the material has a film shape, a surface-direction parallel with a surface of the material may be defined as an x-axis, a surface-direction perpendicular to the x-axis may be defined as a y-axis, and a thickness direction of the material may be defined as a z-axis.

If two of the refractive indexes nx, ny, and nz of a film are equal but the other one is different from the two, the film is defined as a uniaxial film, and if the three refractive indexes nx, ny, and nz of the film are different from one another, the film is defined as a biaxial film.

If a refractive index of the axial film in a surface direction of the axial film is different from the other two refractive indexes, the axial film is defined as an A plate. In addition, if the refractive index nx of the A plate is greater than the refractive index ny of the A plate, the A plate is defined as a +A plate, and if the refractive index nx of the A plate is less than the refractive index ny of the A plate, the A plate is defined as a −A plate.

If the refractive index nz of the axial film is different from the other two refractive indexes of the axial film, the axial film is defined as a C plate. In addition, if the refractive index nz of the C plate is greater than the refractive indexes nx and ny of the C plate, the C plate is defined as a +C plate, and if the refractive index nz of the C plate is less than the refractive indexes nx and ny of the C plate, the C plate is defined as a −C plate.

The biaxial film causes phase differences in its surface directions and thickness direction. If the refractive index nz of the biaxial film is greater than the refractive indexes nx and ny of the biaxial film, the biaxial film is defined as a +biaxial film, and if the refractive index nz of the biaxial film is less than the refractive indexes nx and ny of the biaxial film, the biaxial film is defined as a −biaxial film.

When the first retardation film 210 is viewed in a plan view, the first retardation film 210 has a first axis and a second axis, and a refractive index of the first retardation film 210 in the second axis is less than a refractive index of the first retardation film 210 in the first axis. When the second retardation film 220 is viewed in a plan view, the second retardation film 220 has a first axis and a second axis, and a refractive index of the second retardation film 220 in the second axis is less than a refractive index of the second retardation film 220 in the first axis. That is, at least surface-direction refractive indexes of the first and second retardation films 210 and 220 are different. In the following description, the first direction will be referred to as a y-axis, and the second direction will be referred to as an x-axis. That is, each of the first and second retardation films 210 and 220 may be an A plate or a biaxial film.

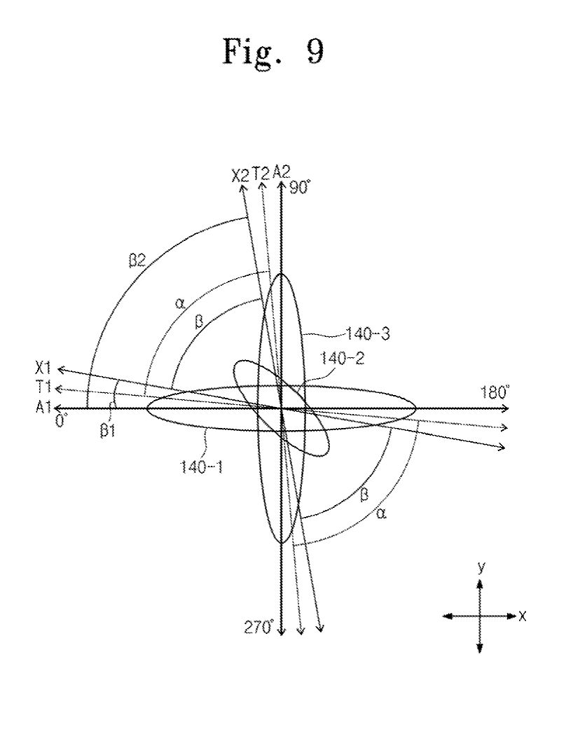

FIG. 9 is a view for explaining a relationship between a twist range angle and a retardation compensation range angle when the liquid crystal display device of FIG. 1 is in an active state. FIG. 9 illustrates a case where a −A plate is used as the first retardation film 210, and a +A plate is used as the second retardation film 220 as shown in FIG. 1.

The lower liquid crystals 140-1 (illustrated in the example of FIG. 5) are twisted from the first alignment axis Al in the first range. The twisted degree of the lower liquid crystals 140-1 from the first alignment axis A1 can be determined by calculating the average of twist angles (twist angle average) of the lower liquid crystals 140-1. An axis representing the twist angle average is defined as a first twist axis T1. Similarly, an axis representing the twist angle average of the upper liquid crystals 140-3 (illustrated in the example of FIG. 5) is defined as a second twist axis T2. In addition, an angle between the first twist axis T1 and the second twist axis T2 is defined as a twist range angle α.

The twist range angle α is in the range from about 88° to about 89.5°. Since the liquid crystals 140 have the twist range angle α, light passing through the liquid crystals 140 is retarded, and the front contrast ratio of the liquid crystal device is lowered.

The first and second retardation films 210 and 220 compensate for such retardation to improve the front contrast ratio of the liquid crystal display device. That is, the first and second retardation films 210 and 220 prevent an optical activation effect or a birefringence effect.

An angle between an x-axis X1 of the first retardation film 210 and an x-axis X2 of the second retardation film 220 is defined as a retardation compensation range angle β. The retardation compensation range angle β is smaller than the twist range angle α.

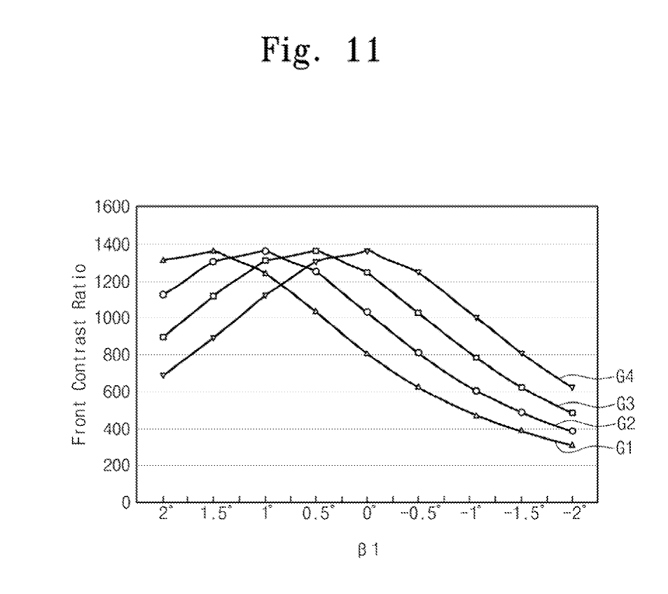

The retardation compensation range angle β may be in the range from about 87.5° to about 89°. For example, the retardation compensation range angle β may be about 88.5°. An explanation on how much the front contrast ratio of the liquid crystal display device is improved by the retardation compensation range angle β will be given later with reference to FIG. 11.

When the retardation compensation range angle β is about 88.5°, the x-axis X1 of the first retardation film 210 may make an angle β1 of about 0° to 1.5° with the first alignment axis A1, and the x-axis X2 of the second retardation film 220 may make an angle β2 of about 88.5° to about 90° with the first alignment axis A1.

The x-axis X1 of the first retardation film 210 and the x-axis X2 of the second retardation film 220 may be provided between the first twist axis T1 and the second twist axis T2.

Although the first and second retardation films 210 and 220 shown in FIG. 1 are A plates having different surface-direction refractive indexes, biaxial films in which thickness-direction refractive indexes are different from other refractive indexes may be used as the first and second retardation films 210 and 220.

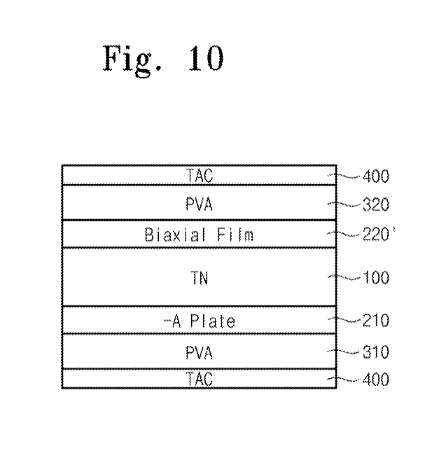

Referring to FIG. 10, in a liquid crystal device of another embodiment of the invention, a biaxial film is used as a second retardation film 220′ instead of a +A plate (illustrated in the example of FIG. 1). For adjusting the retardation compensation range angle β of the liquid crystal device of the current embodiment to the same value as the retardation compensation range angle β of the liquid crystal device of FIG. 1, the x-axis refractive index nx of the second retardation film 220′ may be less than the y-axis refractive index ny of the second retardation film 220′. For example, the second retardation film 220′ may be a C plate in which a z-axis refractive index is different from surface-direction refractive indexes.

In the embodiment shown in FIG. 10, a biaxial film may be used as a first retardation film 210. For example, the first retardation film 210 may be a −A plate in which the x-axis refractive index nx of the first retardation film 210 may be less than the y-axis refractive index ny of the first retardation film 210. Alternatively or additionally, the first retardation film 210 may be a C plate in which a z-axis refractive index is different from surface-direction refractive indexes.

In addition, as shown in FIGS. 1 and 10, the liquid crystal display devices may further include protection films 400 to protect the first and second polarizers 310 and 320. The protection films 400 may be disposed on the bottom side of the first polarizer 310 and the top side of the second polarizer 320, respectively. For example, the protection films 400 may be formed of tri-acetyl-cellulose. Protection films (not shown) may be further disposed between the polarizers 310 and 320 and the retardation films 210 and 220.

An explanation will now be given of the front contrast ratio of the liquid crystal display device with reference to FIG. 11. Results of simulations performed to evaluate the front contrast ratio of the liquid crystal display device are shown by curves G1 through G4 of FIG. 11. The curves G1 through G4 were obtained for different angles β2 between the x-axis X2 of the second retardation film 220 and the first alignment axis A1. Each of the curves G1 through G4 shows the relationship between the front contrast ratio of the liquid crystal device and the angle β1 of the x-axis X1 of the first retardation film 210 from the first alignment axis A1.

In detail, the curve G1 was obtained in the case where the angle β2 between the x-axis X2 and the first alignment axis A1 was 90°, the curve G2 was obtained in the case where the angle β2 was 89.5°, the curve G3 was obtained in the case where the angle β2 was 89°, and the curve G4 was obtained in the case where the angle β2 was 88.5°.

In a typical liquid crystal display device, x-axes of retardation films are perpendicular to or parallel with a first alignment axis. That is, the retardation compensation range angle β between the x-axes are 90°. Therefore, retardation of light passing through a liquid crystal layer is not sufficiently compensated for. As a result, the front contrast ratio of the general liquid crystal device is low.

However, referring to FIG. 11, in the case of the liquid crystal display device described with reference to FIGS. 1 to 10, the retardation compensation range angle β is in the range from about 87.5° to about 89° and less than the twist range angle α. Therefore, retardation of light passing through the lower liquid crystals 140-1 (illustrated in the example FIG. 5) and the upper liquid crystals 140-3 (illustrated in the example of FIG. 5) can be sufficiently compensated for. Accordingly, the front contrast ratio of the liquid crystal display device of the invention may be greater than that of a typical liquid crystal display device.

As described above, the liquid crystal device includes the first and second retardation films on the top and bottom sides of the twisted nematic liquid crystal panel, and the retardation compensation range angle is smaller than the twist range angle. Therefore, the front contrast ratio of the liquid crystal panel can be improved.

In addition, since the liquid crystal display device includes the retardation films instead of discotic liquid crystal (DLC) compensation films, the manufacturing cost of the liquid crystal display device can be reduced.

The above-disclosed subject matter is to be considered illustrative and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A liquid crystal display device comprising:
a twisted nematic liquid crystal panel comprising a first substrate defining a first alignment axis, a second substrate opposite to the first substrate and defining a second alignment axis, and liquid crystals gradually twisted from the first alignment axis to the second alignment axis, wherein if an electric field is applied to the liquid crystals, the liquid crystals include lower liquid crystals having twist angles in a first range, upper liquid crystals having twist angles in a second range different from the first range, and intermediate liquid crystals disposed between the upper and lower liquid crystals;
a first retardation film disposed at a bottom side of the first substrate, wherein a refractive index of the first retardation film in a first axis of the first retardation film is greater than a refractive index of the first retardation film in a second axis of the first retardation film, the first axis of the first retardation film and the second axis of the first retardation film being parallel with a surface of the first retardation film; and
a second retardation film disposed at a top side of the second substrate, wherein a refractive index of the second retardation film in a first axis of the second retardation is greater than a refractive index of the second retardation film in a second axis of the second retardation film, the first axis of the second retardation film and the second axis of the second retardation film being parallel with a surface of the second retardation film,
wherein a retardation compensation range angle between the second axis of the first retardation film and the second axis of the second retardation film in a plan view of the liquid crystal display device is smaller than a twist range angle between a first twist axis representing an average of the twist angles of the lower liquid crystals and a second twist axis representing an average of the twist angles of the upper liquid crystals in the plan view of the liquid crystal display device.

2. The liquid crystal display device of claim 1, further comprising:
a first polarizer disposed at a bottom side of the first retardation film and comprising a first transmission axis; and
a second polarizer disposed at a top side of the second retardation film and comprising a second transmission axis.

3. The liquid crystal display device of claim 2, wherein the first transmission axis is parallel with the first alignment axis, and the first and second transmission axes are perpendicular to each other.

4. The liquid crystal display device of claim 2, wherein the first transmission axis is parallel with the first alignment axis, and the first and second transmission axes are parallel with each other.

5. The liquid crystal display device of claim 1, wherein a refractive index of the first retardation film in a third axis of the first retardation film perpendicular to the first retardation film is different from the refractive indexes of the first retardation film in the first and second axes.

6. The liquid crystal display device of claim 5, wherein a refractive index of the second retardation film in a third axis of the second retardation film perpendicular to the second retardation film is different from the refractive indexes of the second retardation film in the first and second axes.

7. The liquid crystal display device of claim 1, wherein the twist range angle ranges from about 88° to about 89.5°.

8. The liquid crystal display device of claim 7, wherein the retardation compensation range angle ranges from about 87.5° to about 89°.

9. The liquid crystal display device of claim 1, wherein the retardation compensation range angle is about 88.5°.

10. The liquid crystal display device of claim 9, wherein an angle between the second axis of the first retardation film and the first alignment axis in the plan view of the liquid crystal display device is in a range from about 0° to about 1.5°, and
an angle between the second axis of the second retardation film and the first alignment axis in the plan view of the liquid crystal display device is in a range from about 88.5° to about 90°.

11. The liquid crystal display device of claim 1, wherein the second axis of the first retardation film and the second axis of the second retardation film are disposed between the first and second alignment axes in the plan view of the liquid crystal display device.

12. The liquid crystal display device of claim 11, wherein the twist range angle ranges from about 88° to about 89.5°.

13. The liquid crystal display device of claim 12, wherein the retardation compensation range angle ranges from about 87.5° to about 89°.

14. The liquid crystal display device of claim 11, wherein the retardation compensation range angle is about 88.5°.

15. The liquid crystal display device of claim 1, wherein the first substrate comprises an active region and a non-active region around the active region,
the active region comprises a plurality of data lines and a plurality of gate lines crossing the data lines so as to define a plurality of pixel regions, and
the pixel regions comprise a plurality of pixels, respectively.

16. The liquid crystal display device of claim 15, wherein the second substrate comprises:
a black matrix comprising openings corresponding to the pixel regions;
color filters provided at the openings; and
a common electrode disposed on the black matrix and the openings.

17. A liquid crystal display device comprising:
a twisted nematic liquid crystal panel comprising a top surface and a bottom surface;
a lower polarizer disposed at the bottom surface of the twisted nematic liquid crystal panel and associated with a first transmission axis;
an upper polarizer disposed at the top surface of the twisted nematic liquid crystal panel and associated with a second transmission axis perpendicular to the first transmission axis;
a lower retardation film disposed between the twisted nematic liquid crystal panel and the lower polarizer, wherein a refractive index of the lower retardation film in a first axis of the lower retardation film is greater than a refractive index of the lower retardation film in a second axis of the lower retardation film, the first axis of the lower retardation film and the second axis of the lower retardation film being parallel with a surface of the lower retardation film; and
an upper retardation film disposed between the twisted nematic liquid crystal panel and the upper polarizer, wherein a refractive index of the upper retardation film in a first axis of the upper retardation film is greater than a refractive index of the upper retardation film in a second axis of the upper retardation film, the first axis of the upper retardation film and the second axis of the upper retardation film being parallel with a surface of the upper retardation film,
wherein a retardation compensation range angle between the second axis of the lower retardation film and the second axis of the upper retardation film in a plan view of the liquid crystal display device is smaller than an angle between the first transmission axis and the second transmission axis in the plan view of the liquid crystal display device, and the second axis of the lower retardation film and the second axis of the upper retardation film are located between the first transmission axis and the second transmission axis in the plan view of the liquid crystal display device.

18. The liquid crystal display device of claim 17, wherein the twisted nematic liquid crystal panel comprises:
a lower substrate disposed at the bottom surface of the twisted nematic liquid crystal panel and defining a first alignment axis parallel with the first transmission axis;
an upper substrate disposed at the top surface of the twisted nematic liquid crystal panel to face the lower electrode, the upper substrate defining a second alignment axis parallel with the second transmission axis; and
liquid crystals gradually twisted from the first alignment axis to the second alignment axis, wherein if an electric field is applied to the liquid crystals, the liquid crystals include lower liquid crystals having twist angles in a first range, upper liquid crystals having twist angles in a second range different from the first range, and intermediate liquid crystals disposed between the upper and lower liquid crystals.

19. The liquid crystal display device of claim 18, wherein
a first twist axis represents an average of the twist angles of the lower liquid crystals from the first transmission axis,
a second twist axis represents an average of the twist angles of the upper liquid crystals from the first transmission axis, and
wherein a twist range angle between the first twist axis and the second twist axis is smaller than the angle between the first transmission axis and the second transmission axis but greater than the retardation compensation range angle in the plan view of the liquid crystal display device.

20. The liquid crystal display device of claim 19, wherein the twist range angle ranges from about 88° to about 89.5°.

21. The liquid crystal display device of claim 20, wherein the retardation compensation range angle ranges from about 87.5° to about 89°

22. The liquid crystal display device of claim 17, wherein the retardation compensation range angle is about 88.5°.

23. The liquid crystal display device of claim 17, wherein a refractive index of the lower retardation film in a third axis of the lower retardation film perpendicular to the lower retardation film is different from the refractive indexes of the lower retardation film in the first and second axes.

24. The liquid crystal display device of claim 23, wherein a refractive index of the upper retardation film in a third axis of the upper retardation film perpendicular to the upper retardation film is different from the refractive indexes of the second retardation film in the first and second axes.
